(19) United States
(12) Patent Application Publication
(10) Pub. No.: US 2025/0115975 A1
(43) Pub. Date: Apr. 10, 2025

(54) METAL LEACHING PROCESS AND APPARATUS

(71) Applicant: COMMONWEALTH SCIENTIFIC AND INDUSTRIAL RESEARCH ORGANISATION, Acton (AU)

(72) Inventors: Keith Raymond BARNARD, Waterford (AU); Denis William SHIERS, Waterford (AU)

(21) Appl. No.: 18/695,478

(22) PCT Filed: Sep. 30, 2022
(86) PCT No.: PCT/AU2022/051171

§ 371 Date: Mar. 26, 2024

(30) Foreign Application Priority Data
Sep. 30, 2021 (AU) 2021903129

(51) Int. Cl. C22B 3/10; C22B 3/00; C22B 15/00; C25B 1/26; C25B 15/08

(52) U.S. Cl. CPC C22B 3/10; C22B 15/0069; C22B 23/0423; C25B 1/26; C25B 15/081; C25B 15/087

(57) ABSTRACT

The invention relates to a process for leaching metals from metal sulfide ore and/or concentrate, comprising: electrolytically generating a leach solution of oxidative halogen-based lixiviant; contacting the metal sulfide ore and/or concentrate with the leach solution of oxidative halogen-based lixiviant to produce a metal-bearing solution; and passing the metal-bearing solution to metal separation.

### TECHNICAL FIELD

The present invention relates to a process for leaching metals from metal sulfide ores and concentrates. The present invention also relates to an apparatus for leaching metals from metal sulfide ores and concentrates.

### BACKGROUND OF INVENTION

The hydrometallurgical processing of metal sulfide ores and concentrates, particularly low-grade sulfide ores, containing valuable base metals such as copper, cobalt and nickel is typically hampered by slow kinetics and inefficient extraction.

Few processes are practiced industrially that are economically viable, and these often rely on large scales to ensure profitability (such as copper heap leaching). In the case of copper heap leaching, extraction is usually incomplete, with extraction predominantly from oxidised and secondary sulfide minerals. Primary sulfide minerals, that can make up the bulk of a mineral deposit, are not economically processed using these techniques. In addition, the incomplete leaching of sulfide minerals results in these remaining in waste dumps/heaps and in turn result in ongoing environmental impact in the form of acid mine drainage as these sulfide minerals slowly oxidise. Elimination of sulfides present or relocation in anaerobic environments are the only permanent solutions to this problem.

Various chemical and biologically catalysed systems have been tested at laboratory scale to investigate technologies that can achieve improved kinetics and efficient extraction of low-grade sulfides. These have generally focused on the leaching of chalcopyrite (a primary copper sulfide), as it makes up extensive reserves of copper worldwide, and is also contained in many mine waste sites. Nickel, zinc and cobalt containing sulfide ores have also been investigated. More aggressive systems, which offer improved kinetics and increased final recoveries are often operated at temperatures well above ambient. Systems trialed include combinations of mineral acids (such as sulfuric, nitric, hydrochloric acid) and oxidants (such as cupric/cuprous, ferrous/ferric, hydrogen peroxide, dichromate, nitrate, oxygen, ozone, peroxodisulfate, chlorate, chlorine, and hypochlorous acid). Many of these systems suffer from poor environmental compatibility, high expense and/or complications to incorporation in traditional flowsheets, rendering them impractical for commercial application.

One of these chemical systems, hypochlorous acid, has been identified as an oxidant that can circumvent many of these issues, reacting rapidly and completely with sulfide minerals. However, the proposed uses of this lixiviant system envisage high concentrations of hypochlorous acid in the leach solution and/or a single pass leach configuration. The purchase, transportation and use of this reagent is thus currently cost prohibitive and it has not been widely adopted to recover values from metal sulfide ores and concentrates at commercial scale.

There is therefore an ongoing need for improved processes of recovering metals from metal sulfide ores and concentrates which at least partially address one or more of the above-mentioned shortcomings or provide a useful alternative.

It is a desired feature of the process of the present invention to develop a process for recovering metals from metal sulfide ores and concentrates in a manner which improves safety and minimises costs.

It is a desired feature of the process of the present invention to develop a process where metals, such as copper, cobalt, nickel and others, may be recovered from metal sulfide ores and concentrates in a manner that provides greater economic value in the recovery of the metal.

It is a desired feature of the process of the present invention to develop a process where metals such as copper, nickel, cobalt and others may be recovered from metal sulfide ores and concentrates in a manner which minimises the long-term environmental impact of the process.

A reference herein to a patent document or other matter which is given as prior art is not to be taken as an admission that the document or matter was known or that the information it contains was part of the common general knowledge as at the priority date of any of the claims.

### SUMMARY OF INVENTION

A first aspect of the present invention provides a process for leaching metals from metal sulfide ore and/or concentrate, comprising: electrolytically generating a leach solution of oxidative halogen-based lixiviant; contacting the metal sulfide ore and/or concentrate with the leach solution of oxidative halogen-based lixiviant to produce a metal-bearing solution; and passing the metal-bearing solution to metal separation.

Electrolytic generation of the oxidative lixiviant allows the leach solution to be produced on location for the leaching of metals from metal sulfide ore and/or concentrate such as the leaching of currently uneconomic, low grade mineral sulfides as well as treatment of residual sulfide material in acid-leached heaps or tailing products.

The leach solutions may be produced by electrolytic oxidation of dissolved halide in an aqueous precursor solution to form the oxidative halogen-based lixiviant (such as hypochlorous acid) in situ in the leach solution or in an aqueous feed to the leach solution (“in situ electrolysis”). This approach may be distinguished from commercial methods for producing concentrated hypochlorous acid or hypochlorite solutions, which involve dissolution of chlorine gas into aqueous solution. Surprisingly, it has been found that leach solutions practically attainable by in situ electrolysis are capable of effective metal extraction from metal sulfide ores or concentrates, despite the comparatively low concentrations of oxidative halogen-based lixiviant. By contrast, halogen-based leach solutions previously employed for metal extraction from sulfidic materials have generally employed lixiviant concentrations above the range that can be readily generated in situ.

A further advantage of lixiviant generation by in situ electrolysis is that it provides the opportunity to regenerate the lixiviant by recycling the metal-depleted solution, arising from prior recovery of metals from the metal-bearing solution, through the in situ electrolytic oxidation process which generates the leach solution. The halogen-based reagent is thus cycled through a closed loop process (electrolysis—leach—metal separation—electrolysis), providing cost and environmental efficiencies in comparison to a once-through process.

The comparatively low concentrations of oxidative halogen-based lixiviant present in the leach solution, according to some embodiments, may provide additional benefits in the process. The pH drop associated with consumption of the oxidative halogen-based lixiviant is limited by its availability in the leach solution, assisting to maintain the pH within a preferred range during leaching, even if the leach solution contacts a large excess of reactive sulfide (e.g. in heap leaching). By contrast, leaching a metal sulfide ore or concentrate with concentrated hypochlorous acid solution acidifies the leach solution into a pH range where chlorine gas (Cl₂) is the dominant equilibrium species, potentially resulting in halogen losses (off-gassing) and ineffective leaching, particularly in open systems. Furthermore, it has been found that higher reagent consumption efficiencies (moles of oxidative halogen-based lixiviant required per mol of metal leached) are obtained at low lixiviant concentrations.

The leach systems disclosed herein are compatible with other species naturally present in aqueous process streams when leaching metals from sulfidic materials. In particular, leach solutions of oxidative halogen-based lixiviant are effective despite the presence of high background sulfate concentrations. In fact, the presence of sulfate has been shown to provide a number of benefits, including a buffering effect during leaching, thus limiting the drop in pH as the oxidative halogen-based lixiviant is consumed, and stabilisation of metal species present in the aqueous solution when (re)generating the oxidative halogen-based lixiviant in situ.

The process allows the oxidative lixiviant to be generated under ambient conditions providing a safer and more environmentally friendly process. This process also allows for more economic processing, reducing or avoiding storage and transport costs.

In some embodiments of the first aspect, electrolytically generating the leach solution comprises electrolytically oxidising halide in an aqueous precursor solution to produce the oxidative halogen-based lixiviant in situ in the leach solution or in an aqueous feed to the leach solution. The aqueous precursor solution may comprise chloride, bromide, iodide, or a mixture thereof. The aqueous precursor solution may comprise sulfate, optionally present in the aqueous precursor solution at a concentration of at least 0.1 mol/L.

The process may further comprise separating metal from the metal-bearing solution in metal separation to produce a metal-depleted solution comprising halide, and regenerating the oxidative halogen-based lixiviant following metal separation by recycling at least a portion of the metal-depleted solution to form at least a portion of the aqueous precursor solution. The metal-depleted solution may comprise soluble iron. The soluble iron may be removed by oxidation and precipitation before or during the regenerating of the oxidative halogen-based lixiviant.

In some embodiments of the first aspect, the oxidative halogen-based lixiviant is an oxidative chlorine-based lixiviant. In some embodiments of the first aspect, the oxidative chlorine based lixiviant comprises hypochlorous acid.

In some embodiments of the first aspect, the leach solution for contacting the metal sulfide ore and/or concentrate comprises the oxidative halogen-based lixiviant at a concentration of less than 0.15 mol/L, or less than 0.1 mol/L, or less than about 0.05 mol/L. In some embodiments of the first aspect, the leach solution for contacting the metal sulfide ore and/or concentrate comprises the oxidative halogen-based lixiviant at a concentration of less than about 0.005 mol/L, or less than 0.01 mol/L, or less than 0.005 mol/L, or less than 0.003 mol/L, or less than 0.002 mol/L.

In some embodiments of the first aspect, the leach solution for contacting the metal sulfide ore and/or concentrate has a pH of less than 8. In some embodiments of the first aspect, the leach solution for contacting the metal sulfide ore and/or concentrate has a pH of between 3 and 6.5. In other embodiments of the first aspect, the leach solution for contacting the metal sulfide ore and/or concentrate has a pH of below 3.

In some embodiments of the first aspect, the metal-bearing solution has a pH of at least 2, or at least 3, when passed to metal separation.

In some embodiments of the first aspect, the leach solution for contacting the metal sulfide ore and/or concentrate comprises sulfate.

In some embodiments of the first aspect, the contacting step takes place at a temperature of between around 0° C. and 90° C.

In some embodiments of the first aspect, the oxidative halogen-based lixiviant is electrolytically generated using a halogen generator. The halogen generator may be located proximate to a leach environment comprising the sulfide ore and/or concentrate, and the leach solution is transferred by line from the halogen generator to the leach environment for contact with the sulfide ore and/or concentrate. The halogen generator may comprise an inlet, an outlet, and an electrolysis unit comprising at least a pair of electrodes positioned between the inlet and outlet, wherein the electrodes are connected to a power supply. The power supply may be capable of reversing the polarity of the electrodes.

In some embodiments of the first aspect, the oxidative halogen-based lixiviant selectively leaches metal from at least one metal sulfide over another metal sulfide.

In some embodiments of the first aspect, the metal-bearing solution comprises at least one metal selected from copper, nickel and cobalt leached from the metal sulfide ore and/or concentrate.

In some embodiments of the first aspect, the metal sulfide ore and/or concentrate comprises a non-metallic oxidisable solid material, and at least a portion of the non-metallic oxidisable solid material is oxidised when contacting the metal sulfide ore and/or concentrate with the leach solution of oxidative halogen-based lixiviant. The non-metallic oxidisable solid material may comprise a sulfur-containing solid species.

In some embodiments of the first aspect, the process comprises leaching the metal sulfide ore and/or concentrate with a non-oxidative leach solution before and/or after contacting the metal sulfide ore and/or concentrate with the leach solution of oxidative halogen-based lixiviant. The non-oxidative leach solution may be an acid leach solution.

A second aspect of the present invention provides an apparatus for leaching metals from metal sulfide ore and/or concentrate, comprising: a halogen generator, wherein the halogen generator electrolytically generates a leach solution of oxidative halogen-based lixiviant; a leach environment where the metal sulfide ore and/or concentrate is contacted with the leach solution of oxidative halogen-based lixiviant to produce a metal-bearing solution; and means for metal separation from the metal-bearing solution.

Advantageously, this technology can be incorporated readily within new and existing hydrometallurgical unit processes immediately prior to the leaching stage, providing in situ generation of oxidant within leach solutions at low cost, particularly if powered using renewable energy sources.

The process can also be implemented in operations containing sulfidic tailings to accelerate oxidation of residual sulfide materials and thus reduce the ongoing effect and remediation costs of acid mine drainage through an acceleration of the process.

The process also has the capacity to enable a hydrometallurgical-based treatment of sulfide concentrates as opposed to pyrometallurgical processing. This alternate pathway is particularly beneficial for the treatment of “dirty” sulfide concentrates that contain either deleterious/penalty elements (such as arsenic) or to upgrade uncompromised concentrates (to reduce metal value transport costs) through an economic extraction method followed by standard purification technology.

In some embodiments of the second aspect, the halogen generator electrolytically oxidises halide in an aqueous precursor solution to produce the oxidative halogen-based lixiviant in situ in the leach solution or in an aqueous feed to the leach solution.

In some embodiments of the second aspect, the apparatus further comprises a line for recycling a metal-depleted solution from metal separation to the halogen generator allowing for regeneration of the oxidative halogen-based lixiviant.

In some embodiments of the second aspect, the oxidative halogen-based lixiviant is an oxidative chlorine-based lixiviant. In some embodiments of the second aspect, the oxidative chlorine-based lixiviant comprises hypochlorous acid.

In some embodiments of the second aspect, the halogen generator comprises an inlet, an outlet, and an electrolysis unit comprising at least a pair of electrodes positioned between the inlet and outlet, wherein the electrodes are connected to a power supply. The power supply may be capable of reversing the polarity of the electrodes.

In some embodiments of the second aspect, the leach environment is a heap for heap leaching.

A third aspect of the present invention provides a process for leaching metals from an oxidisable ore and/or concentrate, comprising electrolytically generating a leach solution of oxidative halogen-based lixiviant; contacting the oxidisable ore and/or concentrate with the leach solution of oxidative halogen-based lixiviant to produce a metal-bearing solution, and passing the metal-bearing solution to metal separation.

The oxidisable ore and/or concentrate may comprise an oxidisable metal oxide. In some embodiments, the oxidisable ore and/or concentrate is a uranium oxide ore and/or concentrate.

Various optional features of the third aspect are generally as disclosed herein in the context of the first aspect.

Further aspects of the invention appear below in the detailed description of the invention.

### BRIEF DESCRIPTION OF DRAWINGS

Embodiments of the invention will herein be illustrated by way of example only with reference to the accompanying drawings in which:

FIG. 1 is a plot showing the comparison of hypochlorous acid (HClO) to the industrially used ferric sulfate lixiviant system applied to the processing of copper sulfides, using chalcopyrite concentrate, as obtained in Example 1.

FIG. 2 and FIG. 3 are flow diagrams illustrating preferred embodiments of the present invention.

FIG. 4 is a plot showing the results from Example 2, which compared the extraction of copper from chalcopyrite over time at different oxidative chlorine-based lixiviant concentrations (initial pH 5, sulfuric acid).

FIG. 5 is a plot showing the results from Example 3, which compared the extraction of copper from chalcopyrite over time at different oxidative chlorine-based lixiviant concentrations (initial pH 5, hydrochloric acid).

FIG. 6 is a plot showing the results from Example 4, which compared the extraction of copper from chalcopyrite with oxidative chlorine-based lixiviant over time at varied pH (sulfuric acid).

FIG. 7 is a plot showing the results from Example 5, which compared the extraction of copper from chalcopyrite with oxidative chlorine-based lixiviant over time at varied particle size fractions.

FIG. 8 is a plot showing the results from Example 6, which compared the extraction of metals from various metal sulfide concentrates with oxidative chlorine-based lixiviant over time.

FIG. 9 is a plot showing results from Example 7, which compared changes in pH during chalcopyrite concentrate leaching with 0.0004 mol/L oxidative chlorine-based lixiviant in the presence or absence of additional sulfate (20 g/L).

FIG. 10 is a plot showing results from Example 7, which compared changes in pH during chalcopyrite concentrate leaching with 0.0040 mol/L oxidative chlorine-based lixiviant in the presence or absence of additional sulfate (20 g/L).

FIG. 11 is a plot showing the results from Example 8, which investigated the efficiency of chalcopyrite leaching (mol oxidative chlorine-based lixiviant per mol Cu leached) at different concentrations of oxidative chlorine-based lixiviant.

FIG. 12 is a plot showing the results from Example 9, which compared the rate (A) and efficiency (B) of oxidative chlorine-based lixiviant generation using a commercial electrolyser under selected pH conditions.

FIG. 13 is a plot showing the results from Example 10, which investigated the generation of oxidative chlorine-based lixiviant in the presence of soluble ferrous iron.

FIG. 14 is a plot showing the results from Example 11, which investigated the stability of ferric iron during operation of a commercial electrolyser in the presence or absence of sulfate at different pH values.

FIG. 15 is a plot showing the results from Example 12, which demonstrated the extraction of both copper and cobalt from a pulverised ore (−53 μm) sample over time.

FIG. 16 is a flow diagram illustrating a preferred embodiment of the present invention, in which the process is used to augment a heap leaching operation.

FIG. 17 is a plot showing results from Example 13, which compared extraction of a polysulfur solid with a solution of hypochlorous acid and with a solution of sulfuric acid.

### DETAILED DESCRIPTION

Before describing the present invention in detail, it is to be understood that the terminology used herein is for the purpose of describing embodiments only and is not intended to be limiting.

Unless specifically defined otherwise, all technical and scientific terms used herein shall be taken to have the same meaning as commonly understood by one of ordinary skill in the art.

The present invention relates to a process for leaching metals from metal sulfide ore and/or concentrate, comprising electrolytically generating a leach solution of oxidative halogen-based lixiviant; contacting the metal sulfide ore and/or concentrate with the leach solution of oxidative halogen-based lixiviant to produce a metal-bearing solution, and passing the metal-bearing solution to metal separation.

The leach solution is preferably electrolytically generated on location where leaching takes place, for example at a mine or heap leach site. The leach solution may thus be transferred by line from the electrolysis unit to the leach environment where leaching takes place in a single integrated process, in contrast to processes where lixiviant is externally procured and transported to site for use.

In some embodiments, the leach solution is electrolytically generated by electrolytically oxidising halide anions in an aqueous precursor solution to produce the oxidative halogen-based lixiviant in situ (i) in the leach solution (i.e. the aqueous precursor solution is transformed by the oxidation process into the leach solution used for leaching) or (ii) in an aqueous feed to the leach solution (i.e. the aqueous precursor solution, after the oxidation step, is combined with other aqueous feeds to form the leach solution used for leaching). As used herein, producing the oxidative halogen-based lixiviant “in situ” means that the oxidative halogen-based lixiviant is generated by electrolytic reaction in the aqueous phase of a solution which subsequently forms at least a portion of the leach solution, as opposed to dissolution of an externally generated or obtained halogen species (such as Cl₂) into an aqueous solution to produce the leach solution.

The oxidative halogen-based lixiviant may be electrolytically generated using a halogen generator. As used herein, the term “halogen generator”, also known as a salt cell, salt generator, electrolyser, salt halogenator or halogenator cell, is used to refer to a cell which uses electrolysis in the presence of dissolved salt or acid to produce halogen gas or its dissolved forms. For example, a “chlorine generator” uses electrolysis in the presence of dissolved chloride-containing salt or acid to produce chlorine gas or its dissolved forms, hypochlorous acid and hypochlorite. Preferably, the halogen generator is a chlorine generator.

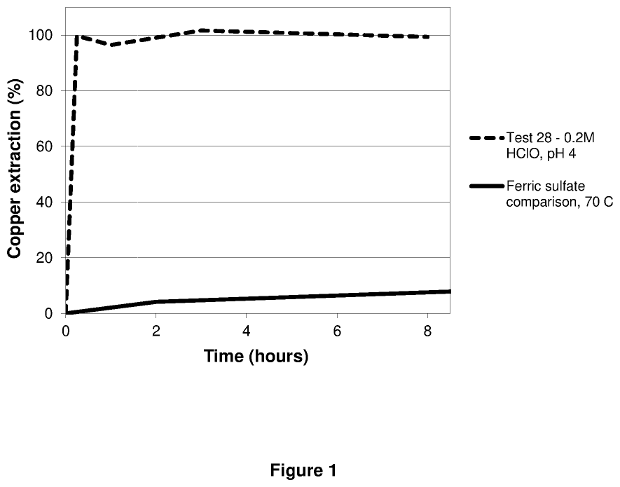

Soluble halogen-based oxidants offer improved reaction kinetics and more complete extraction of metal values from sulfide ores and concentrates in comparison to other industrially used chemicals. This is illustrated in FIG. 1. Electrolytic generation of the oxidant means that the oxidant can be generated on site, and preferably in situ in the bulk leach solution or an aqueous feed to the leach solution, which removes or minimises the requirement for purchase, transport or storage of leach reagents.

Preferably, the oxidative halogen-based lixiviant is generated from an aqueous precursor solution comprising halide, in particular chloride, bromide, iodide, or mixtures thereof. The oxidative halogen-based lixiviant may be generated from a brine solution. An advantage of the present invention is that it can make use of brackish or saline water sources.

In a preferred embodiment, the oxidative halogen-based lixiviant is an oxidative chlorine-based lixiviant. Preferably, the oxidative chlorine based lixiviant comprises hypochlorous acid. Hypochlorous acid (HOCl or HClO) is a weak acid that forms when chlorine dissolves in water, and itself partially dissociates, forming hypochlorite, ClO⁻. Hypochlorous acid may be generated electrolytically from chloride ions in aqueous solution, typically by overall equation (1):

$$NaCl + 2 {H}_{2} O \to {H}_{2} ( g ) + HOCl + NaOH \qquad ( 1 )$$

While hypochlorous acid and its solution equilibrium products such as hypochlorite are preferred, it will be understood that any oxidative halogen-based lixiviant which can be generated electrolytically or via electrolytically generated products is suitable for use with the present invention such as, for example, Cl₂, ClO, ClO₃, ClO₄, Br₂ or I₂.

In a preferred embodiment, the process of the present invention further comprises regenerating the oxidative halogen-based lixiviant following metal separation. This is done by subjecting at least part of the resultant metal-depleted solution to electrolytic oxidation to generate the leach solution (or a feed to the leach solution), typically in a halogen generator. The metal-depleted solution contains halide (e.g. chloride, CI), at least some of which is formed when the oxidative halogen-based lixiviant is consumed (reduced) as it reacts with (oxidises) metal sulfides during leaching. Passing at least part of the metal-depleted solution through the halogen generator allows the oxidative halogen-based lixiviant to be regenerated electrolytically. This means that the oxidant can optionally be regenerated on-site, improving the efficiency of the process and avoiding or minimising the need to dispose of halides from the process which would arise from any ongoing addition of ex situ chlorine species. A further preferred embodiment of the invention also comprises optionally adjusting the pH of the solution prior to returning the solution to the halogen generator. This pH adjustment step can take place either before or preferably after the metal separation step. In one embodiment, the pH of the solution will be adjusted to between around pH 3.0 and pH 6.5. It has been found that in situ electrolytic oxidation of halides in aqueous solution is more efficient at neutral pH values than acidic pH values, and may also reduce the risk of halide loss due to off-gassing. Furthermore, the subsequent leaching of metals has also been found more efficient at neutral pH values. The potential to generate a saleable iron species also exists.

The regeneration of the lixiviant can accommodate various species expected to be present in the metal-depleted solution. Sulfate ions will be present when sulfuric acid is used as the mineral acid component of the leach solution. Moreover, sulfate is produced in the leach process by oxidation of sulfide anions in the metal sulfide ore and/or concentrate, and this sulfate may accumulate in the system when the metal-depleted solution is recycled to the leach solution via electrolysis. In some embodiments, sulfate is thus present in the aqueous precursor solution subjected to electrolytic oxidation in a concentration of at least 0.03 mol/L, or at least 0.1 mol/L, or at least 0.2 mol/L, for example in the range of 0.2 mol/L to 1.3 mol/L. Advantageously, sulfate in such concentrations does not prevent or unacceptably inhibit electrolytic oxidation of the halide to the oxidative halogen-based lixiviant. In fact, the presence of sulfate may advantageously stabilise other species, such as ferric iron, thus avoiding or reducing the formation of precipitates in the halogen generator. As the skilled person will appreciate, the concentrations of accumulating species, such as sulfate, in a closed loop system can be controlled by appropriate purging.

The metal-depleted solution sent for regeneration may further comprise dissolved metals remaining after metal separation, including iron species and unrecovered low concentrations of metal values. Dissolved ferrous ion (Fe²⁺) will be oxidised in preference to halide in the regeneration process, so that oxidative halogen-based lixiviant is expected to begin accumulating in solution only once all Fe²⁺ is removed. This can be achieved by Fe²⁺ oxidation in the halogen generator, or a preliminary electrolysis cell dedicated to this function. The resultant electrochemically oxidised ferric species may at least partially precipitate and thus be removed from the process. However, it has also been found that ferric species are stabilised in solution by sulfate, which may assist to avoid undesirable precipitates in the halogen generator. In other embodiments, iron may be removed during regeneration via a preliminary chemical oxidation and precipitation step before electrolysis. For example, a neutralising agent such as lime can be added to increase the pH to the point where iron hydrolyses to Fe³⁺ and precipitates out. An oxygen-containing gas may be added to facilitate the oxidation. Optionally, the metal-depleted solution is passed through a reservoir to provide sufficient residence time for iron oxidation and precipitation, with the clarified iron-depleted solution then sent for electrolytic oxidation of the halide.

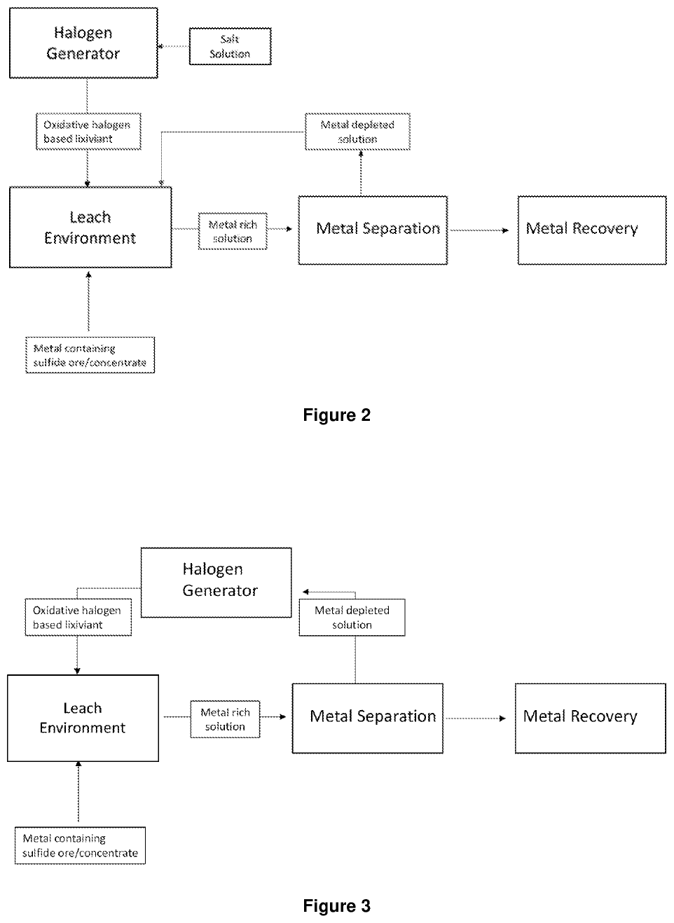

One preferred embodiment of the present invention is shown in FIG. 2. As FIG. 2 shows, the halogen generator provides a leach solution of oxidative halogen-based lixiviant which is generated electrolytically from a salt solution (i.e. via in situ electrolytic oxidation of a halide). This is contacted with metal sulfide ore and/or concentrate in a leach environment. The resultant metal-rich or metal-bearing solution is then passed to metal separation and the separated metal is subsequently sent to metal recovery. The metal-depleted solution is returned to leaching. A further preferred embodiment of the present invention is shown in FIG. 3, where following metal separation, at least part of the resulting metal-depleted solution is passed back to the halogen generator to electrolytically regenerate the oxidative halogen-based lixiviant.

In a preferred embodiment of the process of the present invention, the halogen generator comprises an inlet, an outlet, an electrolysis unit comprising at least a pair of electrodes positioned between the inlet and outlet; and wherein the electrodes are connected to a power supply. Preferably, the at least a pair of electrodes are an arrangement of parallel plates, preferably titanium plates coated with ruthenium, iridium, or oxides, alloys or mixtures thereof. The plates may be perforated, mesh or solid plates.

Depending on operating conditions used, calcium or other precipitate build-up and metal deposition can occur on the cathode, meaning the electrodes may need to be cleaned intermittently. While this can be done periodically with mild acid, it is preferred that the power supply is capable of reversing the polarity of the electrodes, allowing regular switching of the roles of the two electrodes between anode and cathode, causing any calcium and other build-up to dissolve off the accumulating electrode.

The halogen generator may be run continuously or intermittently during metal leaching. Since the leach solution will have a degree of leaching capability even in the absence of the oxidative halogen-based lixiviant, e.g. via acid leaching mechanisms, it is possible to operate the halogen generator only periodically, for example when power is available or suitably low in cost. Thus, the leach process is enhanced by the presence of oxidative halogen-based lixiviant in the leach solution only when it is economic to do so. Advantageously, the halogen generator may thus be capable of being powered by decentralized and/or renewable energy sources such as, for example, solar power, wind power, geothermal energy or battery power, even when such power sources are intermittent.

Preferably, the halogen generator is a chlorine generator. The chlorine generator preferably electrolytically generates a solution of hypochlorous acid.

The leach solution for contact with the metal sulfide ore and/or concentrate may comprise the oxidative halogen-based lixiviant at any concentration which is attainable when electrolytically generating the leach solution, and in particular when the oxidative halogen-based lixiviant is generated in situ in the leach solution or in an aqueous feed diluted into the leach solution. In some embodiments, the concentration of oxidative halogen-based lixiviant in the leach solution when contacted with the metal sulfide ore and/or concentrate is less than 0.15 mol/L, or less than 0.1 mol/L, or less than 0.05 mol/L, or less than 0.01 mol/L, or less than 0.005 mol/L, or less than 0.003 mol/L, or less than 0.002 mol/L, or even less than 0.001 mol/L. In some embodiments, the concentration of oxidative halogen-based lixiviant is at least 0.0001 mol/L, or at least 0.0002 mol/L.

In some embodiments, the leach solution for contact with the metal sulfide ore and/or concentrate comprises sulfate, for example in a concentration of at least 0.03 mol/L, or at least 0.1 mol/L, or at least 0.2 mol/L, for example in the range of 0.2 mol/L to 1.3 mol/L. As already discussed, sulfate is produced in the leach process and will build up in the leach solution if the metal-bearing solution, after metals separation, is recycled back to the leach solution. Advantageously, sulfate does not materially interfere with the oxidative leach process and has been shown to provide a number of benefits including a buffering effect during leaching, which limits the drop in pH as the oxidative halogen-based lixiviant is consumed.

The process of the present invention generally involves leaching at neutral or acidic pH values. The leach solution for contact with the metal sulfide ore and/or concentrate may thus have a pH of less than 8, and preferably less than 7.5, or less than 7 or less than 6.5, with the pH expected to decrease from the initial leach solution pH during leaching. It is envisaged that the present process may, in some embodiments, be used in combination with or to enhance conventional acid leaching operations, either subsequent to an acid leaching step (without oxidative halogen-based lixiviant) or intermittently during acid leaching. For example, copper heap leaching operations typically use sulfuric acid leaching, and oxidative halogen-based lixiviant may be used according to the principles disclosed herein to enhance such leach operations. It will be apparent that alkaline oxidative leaching is not readily compatible with prior or alternating acid leaching process steps. Moreover, alkaline leaching of metal sulfides with oxidative halogen-based lixiviants requires the presence of ammonia to form soluble metal ammine complexes. However, the introduction of ammonia into the leach process is undesirable and may advantageously be avoided in the present process. Accordingly, in at least some embodiments, the leach solution is substantially free of ammonia species (including ammonia, ammonium cations and ammine complexes).

The process generally operates most efficiently at a pH close to neutral (between around pH 3.0 and 6.5) during leaching. This will advantageously reduce the quantity of non-economic soluble metals (gangue) dissolved in solution (such as iron, which will reprecipitate at this pH) and also potentially allow for reduced remediation costs and improved tailings behaviour. In some embodiments, the leach solution for contact with the metal sulfide ore and/or concentrate may thus have a pH of between 3 and 6.5. However, in other embodiments, for example when the oxidative halogen-based lixiviant is used to enhance an acid leach operation, the leach solution for contact with the metal sulfide ore and/or concentrate has a pH of below 3. Leach solutions with such low initial pH values are still effective at leaching sulfidic materials, and the risk of off-gassing chlorine gas (Cl₂) at low pH can be mitigated, for example in an enclosed leach environment or even in heap leaching by injecting the oxidative leach solution into the interior of the heap.

In some embodiments, the contacting step of the present invention takes place at a pH of between around pH 0.5 and pH 8.0. Preferably, between around pH 0.5 and pH 7.5, or between around pH 0.5 and pH 7.0, or between around pH 0.5 and pH 6.5, or between around pH 1.0 and pH 9.0, or between around pH 1.0 and pH 8.5, or between around pH 1.0 and pH 8.0, or between around pH 1.0 and pH 7.5, or between around pH 1.0 and pH 7.0, or between around pH 1.0 and pH 6.5, or between around pH 1.5 and pH 9.0, or between around pH 1.5 and pH 8.5, or between around pH 1.5 and pH 8.0, or between around pH 1.5 and pH 7.5, or between around pH 1.5 and pH 7.0, or between around pH 1.5 and pH 6.5, or between around pH 2.0 and pH 9.0, or between around pH 2.0 and pH 8.5, or between around pH 2.0 and pH 8.0, or between around pH 2.0 and pH 7.5, or between around pH 2.0 and pH 7.0, or between around pH 2.0 and pH 6.5, or between around pH 2.5 and pH 9.0, or between around pH 2.5 and pH 8.5, or between around pH 2.5 and pH 8.0, or between around pH 2.5 and pH 7.5, or between around pH 2.5 and pH 7.0, or between around pH 2.5 and pH 6.5, or between around pH 3.0 and pH 9.0, or between around pH 3.0 and pH 8.5, or between around pH 3.0 and pH 8.0, or between around pH 3.0 and pH 7.5, or between around pH 3.0 and pH 7.0, or between around pH 3.0 and pH 6.5, or between around pH 3.5 and pH 9.0, or between around pH 3.5 and pH 8.5, or between around pH 3.5 and pH 8.0, or between around pH 3.5 and pH 7.5, or between around pH 3.5 and pH 7.0, or between around pH 3.5 and pH 6.5, or between around pH 4.0 and pH 9.0, or between around pH 4.0 and pH 8.5, or between around pH 4.0 and pH 8.0, or between around pH 4.0 and pH 7.5, or between around pH 4.0 and pH 7.0. In some preferred embodiments, the contacting step takes place at a pH of between around pH 3.0 and pH 6.5.

In some embodiments, the pH of the metal-bearing solution after leaching, i.e. when passed to metal separation, has a pH of at least 1.5, or at least 2, for example at least 3. Leaching has been found less efficient at lower pH values, e.g. in the range of 1 to 2, providing an incentive to operate the process such that the leach solution remains at a higher pH, e.g. 3 to 6.5, throughout the contacting step. Moreover, aqueous hypochlorous acid (HOCl) exists in equilibrium with chlorine gas (Cl₂) and hypochlorite (OCl⁻) species, with Cl₂ the dominant equilibrium species at low pH values. Thus, there is a risk of off-gassing residual oxidative halogen-based lixiviant if the pH drops to low values during leaching, particularly in unconfined leaching such as in heap leaching. While it is thus preferred that the leach solution remains in a neutral to weakly acidic range throughout the leaching process, i.e. until metal separation, it should be appreciated that this may not always be possible and the methods disclosed herein can accommodate lower ultimate pH values. For example, the aqueous environment around the metal sulfide ore and/or concentrate prior to the contacting step may be highly acidic, e.g. from an earlier acid leach treatment, so that leaching occurs at low pH values.

The process of the present invention is most efficient at ambient operating temperatures which helps minimise chlorine gas loss as well as decreases energy costs. Reducing volatile chlorine gas loss not only improves the safety of users in the immediate environment but also retains chlorine in the system which improves efficiency. Previously described systems generally have improved kinetics with increased temperature, or a requirement for above ambient temperature conditions, resulting in chlorine gas loss which is both a safety hazard and reduces the efficiency of the process. In some embodiments, the contacting step of the present invention takes place at a temperature of between around 0° C. and 90° C. Preferably, around 5° C. and 90° C., or between around 10° C. and 90° C., or between around 15° C. and 90° C., or between around 20° C. and 90° C., or between around 0° C. and 85° C., or between around 0° C. and 80° C., or between around 0° C. and 75° C., or between around 0° C. and 70° C., or between around 0° C. and 65° C., or between around 0° C. and 60° C., or between around 0° C. and 55° C., or between around 5° C. and 85° C., or between around 5° C. and 80° C., or between around 5° C. and 75° C., or between around 5° C. and 70° C., or between around 5° C. and 65° C., or between around 5° C. and 60° C., or between around 5° C. and 55° C., or between around 10° C. and 85° C., or between around 10° C. and 80° C., or between 10° C. and 75° C., or between around 10° C. and 70° C., or between around 10° C. and 65° C., or between around 10° C. and 60° C., or between around 10° C. and 55° C., or between around 15° C. and 85° C., or between around 15° C. and 80° C., or between 15° C. and 75° C., or between around 15° C. and 70° C., or between around 15° C. and 65° C., or between around 15° C. and 60° C., or between around 15° C. and 55° C., or between around 20° C. and 85° C., or between around 20° C. and 80° C., or between 20° C. and 75° C., or between around 20° C. and 70° C., or between around 20° C. and 65° C., or between around 20° C. and 60° C., or between around 20° C. and 55° C. In some preferred embodiments, the contacting step takes place at a temperature of between around 20° and 50° C.

The term “sulfide metals ores and/or concentrates” encompasses ores and/or concentrates comprising any sulfide minerals where sulfide (S²⁻) or disulfide (S₂²⁻) is the major anion. It will be understood that that this term is not restricted to ores and concentrates in which sulfur is the only non-metallic element and includes selenides, tellurides, arsenides, antimonides, bismuthinides, sulfarsenides and sulfosalts. Examples include, but are not limited, to chalcopyrite, chalcocite, covellite, bornite, enargite, tetrahedrite, digenite, tennantite, pyrite, marcasite, molybdenite, stibnite, pentlandite, millerite, sphalerite, acanthite, cobaltite, gersdorffite, uraninite, argentite, patronite, galena, pyrrhotite, cinnabar, realgar, orpiment, stibnite, cobaltite, arsenopyrite, gersdorffite and mixtures thereof. It will be understood that the target metals for the process of the present invention comprise any metals which form sulfide ores and concentrates such as, for example, metals selected from the list consisting of copper, nickel, zinc, cobalt, gold, silver, molybdenum, vanadium, platinum, ruthenium, rhodium, palladium, osmium, iridium, and mixtures thereof. In some embodiments, the target metals for the process of the present invention are selected from copper, nickel, cobalt and mixtures thereof.

In some embodiments of the present invention, where the sulfide ore and/or concentrate comprises a mixture of metal sulfides, the oxidative lixiviant may be capable of selectively leaching one metal sulfide present over another metal sulfide that is present. For example, one or more of the metal sulfides reacts at a faster rate than or preferentially to another metal sulfide which is present. Preferably, the oxidative halogen-based lixiviant selectively leaches at least one metal sulfide present over another metal sulfide that is present. Without wishing to be bound by theory, it is hypothesised that this selectivity could be induced by altering reaction factors such as the absence of a material excess of hypochlorite in the system or pH manipulation. For example, at pH 3.0 to 6.0, pyrite oxidation is likely limited due to insufficient proton availability, meaning the process of the present invention could potentially be used to selectively extract chalcopyrite over some pyrite. This optional selectivity could result in a more efficient process.

In other embodiments where the sulfide ore and/or concentrate comprises a mixture of metal sulfides, the oxidative lixiviant may be capable of leaching two or more target metals simultaneously.

In some embodiments, the metal sulfide ore and/or concentrate comprises an oxidisable solid material other than a metal sulfide. The oxidisable solid material may act as a barrier (or passivation layer) which prevents or inhibits leach solutions from accessing target metal sulfides in the metal sulfide ore and/or concentrate. For example, the oxidisable solid material may be a non-metallic oxidisable solid material, such as elemental sulfur, polysulfide or other sulfur-containing solid species which are formed as intermediates in the oxidation of metal sulfides to sulfate. Such materials may be formed in situ when leaching metal sulfide ore and/or concentrate. For example, this is a known limitation in ferric sulfate (bacterially catalysed) heap leaching processes for copper extraction from chalcopyrite. By contacting the metal sulfide ore and/or concentrate with the leach solution of oxidative halogen-based lixiviant, as disclosed herein, at least a portion of the oxidisable solid material is oxidised and solubilised. This may advantageously expose the underlying metal sulfides to leaching resulting in improved total extraction. The inventors have found that partially reduced sulfur-containing solids, such as polysulfide, are readily oxidised by leach solutions of oxidative halogen-based lixiviant as disclosed herein.

In some embodiments, the metal sulfide ore and/or concentrate is contacted with the leach solution of oxidative halogen-based lixiviant intermittently during an extended leach process to remove an oxidisable solid material formed in situ during the leach process when leaching with a different, non-oxidative or weakly oxidative leach solution. In some embodiments, the metal sulfide ore and/or concentrate used in the process of the invention has been subjected to a prior leach process, for example ferric sulfate bacterially catalysed leaching, which produced the oxidisable solid material in situ. The present invention may thus allow further recovery of metal values from ores which are no longer economically leachable by conventional leach technology due to build-up of oxidisable solid material barriers.

The process disclosed herein comprises a step of passing the metal-bearing solution produced by contacting the metal sulfide ore and/or concentrate with the leach solution to metal separation. As used herein, metal separation refers to any one or more process steps where the leached metal is separated from the metal-bearing solution for subsequent recovery from the process. Metal separation typically results in the production of a metal-depleted solution, which may optionally be subjected to regeneration as disclosed herein. The skilled person will understand that metal separation can be achieved by any suitable technique known in the art, such as solvent extraction, cementation or precipitation. Solvent extraction, as routinely used for metal separation in conventional acid leaching operations, is used in some preferred embodiments of the present invention.

In embodiments where the oxidative halogen-based lixiviant is regenerated by recycling the post-leach solution through an electrolytic process to re-oxidise the halide, metal separation and electrolytic generation of the leach solution of oxidative halogen-based lixiviant may be separate process steps as already disclosed herein. For example, the metal-bearing solution is subjected to a metal separation process such as solvent extraction to produce a metal-depleted solution comprising halide, and the metal-depleted solution is then then recycled to a halogen generator where the halide is electrolytically oxidised to produce the oxidative halogen-based lixiviant.

However, it is not excluded that metal separation and lixiviant regeneration may be performed in a single process step or process unit. For example, the inventors have demonstrated that a leach solution contacting ferrous iron, chloride and sulfate may be subjected to a single electrolytic process which consecutively (i) oxidises and precipitates the iron (as ferric iron species) and (ii) oxidises the halide to oxidative halogen-based lixiviant. In addition, the lixiviant regeneration reaction, e.g. via equation (1), may generate hydroxide, thus affecting localised pH which may precipitate certain metals. Through judicious selection of operating conditions, it is thus expected that a post-leach metal-bearing solution comprising other leached metals and halide may similarly be subjected to simultaneous or consecutive metal separation (by oxidation and/or pH adjustment and subsequent precipitation) and lixiviant regeneration (by halide oxidation) in an electrolytic cell (or cells). For example, leached manganese in the metal-bearing solution may be oxidised from 2+ to 4+ oxidation state, resulting in manganese precipitation. As another example, leached cobalt is expected to precipitate when the pH of the metal-bearing solution increases during lixiviant regeneration.

Once separated from the metal-bearing solution, metal values may be recovered using conventional metal recovery techniques, such as electrowinning. In some conventional acid leaching operations, metals separated from the metal-bearing solution by solvent extraction are stripped from the organic solution into a second aqueous solution and subsequently recovered by electrowinning. The same approach to metal recovery is considered suitable for any leaching operations enhanced by addition of an oxidative halogen-based lixiviant, as disclosed herein.

An exemplary embodiment, in which the process disclosed herein is used to augment an acid (heap) leaching operation, will now be described with reference to FIG. 16. Leach environment 100 comprises a heap of crushed ore 102, for example a copper-bearing ore comprising chalcopyrite. Consistent with currently practiced heap leach methodologies, ore 102 is leached using sulfuric acid-based leach solution 104 to produce metal-bearing solution (pregnant leach solution; PLS) 106. Metal-bearing solution 106, recovered from the heap, is passed to metal separation to separate metals and produce a metal-depleted solution (raffinate) 110. Metal separation comprises solvent extraction via solvent extraction unit 108 and stripping unit 114. Thus, copper in PLS 106 is extracted into an organic solvent in solvent extraction unit 108 to produce copper-loaded organic solution 112 and aqueous (metal-depleted) raffinate 110, with raffinate 110 typically being reacidified by exchange of protons with metal ions in the solvent exchange process. Copper-loaded organic solution 112 is then subjected to stripping of copper from the organic solution via contact with a highly acidic aqueous electrolyte in stripping unit 114, with the stripped organic solvent 116 recycled to solvent extraction unit 108. Pregnant electrolyte 118 is sent to electrowinning unit 120 for recovery of refined copper 122, with the spent electrolyte 124 recycled to stripping unit 114. Raffinate 110 is recycled via main recycle line 126 to become leach solution 104.

Leaching can be continued in this manner for as long as a satisfactory recovery of metal (copper) values from ore within leach environment 100 is obtained using the conventional acid-based leach solution. Eventually, however, metal recovery will decline as the acid-leachable oxidised and secondary sulfide minerals in the ore are exhausted. To maintain satisfactory rates of metal recovery, additional ore 102 is added and/or it becomes necessary to leach the primary metal sulfide minerals in the ore within leach environment 100, for example chalcopyrite.

Thus, some or all of raffinate 110 is recycled to leach solution 104 via by-pass recycle line 128 to electrolytically generate a leach solution of oxidative halogen-based lixiviant. Raffinate 110 may optionally first pass through metal precipitation unit 130 to remove some or all of the dissolved metal content remaining in the raffinate following solvent extraction. Precipitation may be induced by pH adjustment, for example by adding lime or other base. For example, raffinate 110 may comprise dissolved ferrous iron which is hydrolysed to ferric iron and precipitated by addition of lime and optionally also air. This avoids or mitigates electrochemical oxidation of ferrous ion and resultant iron precipitation in the subsequent electrolysis step. Even in the absence of a metal precipitation step, the raffinate stream recycled via line 128 may optionally be subjected to pH adjustment, for example to a pH in the range of 3 to 6.5, to facilitate the subsequent electrolysis step and leaching steps as disclosed herein.

The metal-depleted raffinate is then sent to halogen generator 132. There, a halide present in the raffinate, preferably chloride, is oxidised in situ in the raffinate to form the oxidative halogen-based lixiviant, preferably an oxidative chlorine-based lixiviant which most preferably comprises hypochlorous acid (HOCl), at least as the predominant equilibrium species. If the entire raffinate stream 110 is sent via by-pass recycle line 128, the aqueous electrolysis product 134 forms substantially all of leach solution 104. Alternatively, if only a portion of raffinate 110 is sent via by-pass recycle line 128, aqueous electrolysis product 134 is combined with the remaining portion of raffinate 110 (sent via main recycle line 126) to form leach solution 104. In either case, the concentration of oxidative halogen-based lixiviant present in leach solution 104 is no greater than the concentration that can be produced in situ in halogen generator 132.

Ore 102 in leach environment 100 is then further treated with the oxidative lixiviant present in the leach solution 104 facilitating metal extraction from metal sulfides (including chalcopyrite) present in the ore. It will be appreciated that the pH of leach solution 104, the leach solution in leach environment 100 and PLS 106 may vary depending on the mode of implementation. In some embodiments, the pH of leach solution 104 is between 3 and 6.5, with the pH of PLS 106 preferably remaining above 2, or above 3, after leaching. Such pH ranges may be achievable, for example, if oxidative leaching is operated continuously for extended periods following acid leaching, e,g. to extend the life of a heap after acid-leachable minerals are exhausted. In other embodiments, PLS 106 may be highly acidic (pH less than 3, or less than 2) despite the use of a neutral (pH 3 to 6.5) leach solution 104, due to mixing of the leach solution with sulfide ores that are capable of generating acid when oxidised, such as pyrite. In yet other embodiments, leach solution 104 may itself be acidic (pH less than 3, or less than 2). For example, oxidative lixiviant produced in halogen generator 132 may be added continuously or intermittently to the bulk recycle stream (sent via line 126) during acid leaching of ore 102 contained within the leach environment 100. Low pH leaching with oxidative halogen-based lixiviant can be accommodated provided that care is taken to minimise off-gassing of halogen species (particularly Cl₂). For example, leach solution 104 may be injected into the interior of the heap, and the oxidative halogen-based lixiviant may be fully consumed before PLS 106 is recovered from the heap. Alternatively, a leach solution containing only electrolysis product 134 is injected into the interior of the heap while the non-oxidised raffinate returned via main recycle line 126 is irrigated onto the surface of the heap.

Advantageously, the process disclosed herein thus provides the opportunity to enhance metal recovery from existing or new acid (heap) leach operations with minimal change to the overall flow sheet: it is only necessary to add halide into the process stream, typically in much smaller concentrations than the sulfate matrix, and to incorporate a halogen generator in a recycle line from metal separation for oxidation of the halide when desirable to do so. Acid heap leach operations typically use sulfuric acid as the mineral acid lixiviant. Although it is not conventional for halogen species to be added to the process streams using solvent extraction given the potential for chloride carryover into downstream stages such as electrowinning circuits, it has been a challenge that has been successfully overcome where it occurs, particularly in South America. Contrary to prevailing practices, therefore, the inventors have found that a halide component in the process stream can enhance the rate of leaching and/or facilitate leaching from ores and concentrates not suitably susceptible to (or no longer susceptible to) acid leaching. This is done by oxidising the halide to produce a leach solution containing an oxidative lixiviant, on location at the heap leach operation, preferably in situ in the recycle stream, despite the presence of much larger concentrations of sulfate and other ionic components in the process streams, and despite the comparatively low concentration of the oxidative lixiviant that can be produced in the resultant leach solution.

It will be appreciated that the process depicted in FIG. 16 is subject to a range of other variations. For example: (i) different metal sulfides, for example a variety of copper, nickel and cobalt sulfides, present in ore 102 may be subjected to oxidative leaching, (ii) different metal separation (and metal recovery) technologies, such as cementation, may be used to separate metals from PLS 106 and produce raffinate 110, (iii) halogen generator 132 may be included in main recycle line 126 (with line 128 absent), (iv) halogen generator 132 may, in principle, be present in a feed line to leach solution 103, thereby generating oxidative lixiviant for once-through (non-recycled) leaching from a halide-containing feed solution (e.g. a brine), (v) precipitation unit 130 may be an electrolytic reactor for electrochemical oxidation and precipitation of ferrous and other metals, (vi) electrolysis product 134 may be added directly to a different point in the leach environment 100 and separate to the non-oxidised raffinate returned via main recycle line 126, (vii) purge and make-up streams may be added to the flow scheme, according to standard practice, to maintain solution concentrations within desirable ranges, and (viii) a non-sulfidic ore 102, for example comprising an oxidisable metal oxide (such as a uranium oxide) may be subjected to oxidative leaching.

The present invention also relates to an apparatus, or system, for leaching metals from metal sulfide ore and/or concentrate, comprising a halogen generator, wherein the halogen generator electrolytically generates a solution of the oxidative halogen-based lixiviant; a leach environment where the metal sulfide ore and/or concentrate is contacted with the solution of oxidative halogen-based lixiviant to produce a metal-bearing solution; and means for metal separation from the metal-bearing solution.

As used herein, the term “leach environment” refers to any suitable vessel, tank, vat, reactor, container, pit, heap or structure in which the metal sulfide ore or concentrate is contacted with the solution of oxidative halogen-based lixiviant to produce a metal-bearing solution. It will be understood that such a leach environment would also extend to in situ leaching of ore. The skilled person will appreciate that the leach environment may be some distance from the halogen generator, and they are connected by any suitable line, piping, tubing or other means of connection which allows the leach solution of oxidative halogen-based lixiviant to pass to the leach environment. One example of a suitable leach environment is an established heap leach that has already been irrigated with acid-based lixiviants so primarily only sulfide ore remains and can be irrigated with oxidative halogen-based lixiviant to recover the remaining metal. Another example of a suitable leach environment is a new heap or a new heap lift that has both oxide and sulfide ores present, which can be irrigated with both acid-based and oxidative halogen-based lixiviants, either separately, sequentially or concurrently.

In a preferred embodiment of the invention, the halogen generator comprises an inlet, an outlet, an electrolysis unit comprising at least a pair of electrodes positioned between the inlet and outlet; and wherein the electrodes are connected to a power supply. Preferably, the power supply is capable of reversing the polarity of the electrodes. Preferably, the halogen generator is a chlorine generator which generates a solution of hypochlorous acid.

The apparatus of the present invention can be used with any suitable downstream metal separation techniques known in the art such as solvent extraction, cementation or precipitation. Metal separation with subsequent metal recovery serves to separate and recover metals from the metal-bearing solution, providing recovered metals and a metal-depleted solution. In some embodiments, metal separation and recovery is achieved by solvent extraction/ion-exchange/electrowinning as disclosed herein.

In some preferred embodiments of the invention, the apparatus further comprises a line for returning the metal-depleted solution following metal separation to the halogen generator allowing for regeneration of the oxidative halogen-based lixiviant. This allows that the oxidant can optionally be regenerated on-site, improving the efficiency of the process. This optional modification is also straightforward to scale to the size of an operation and can include the installation of multiple units.

It will be appreciated that while the process and apparatus of the present invention is most suitable for the leaching of metals from sulfide ore and/or concentrate, the invention could also be applicable to the leaching of metals from other, non-sulfidic reduced ores and minerals where metal extraction is enhanced by an oxidative halogen-based lixiviant.

The present invention thus also relates to a process for leaching metals from an oxidisable ore and/or concentrate, comprising electrolytically generating a leach solution of oxidative halogen-based lixiviant; contacting the oxidisable ore and/or concentrate with the leach solution of oxidative halogen-based lixiviant to produce a metal-bearing solution, and passing the metal-bearing solution to metal separation.

In some embodiments, the oxidisable ore and/or concentrate is a metal sulfide ore and/or concentrate, as already described herein. In other embodiments, the oxidisable ore and/or concentrate comprises an oxidisable metal oxide. Oxidisable metal oxides generally include metals having an oxidation state which renders them susceptible to oxidation to higher oxidation states. For example, the oxidisable metal ore and/or concentrate may be a uranium oxide ore and/or concentrate which comprises tetravalent uranium (U⁴⁺). Leaching of uranium from such materials is facilitated by an oxidative halogen-based lixiviant capable of oxidising the tetravalent uranium to soluble, hexavalent uranium (U⁶⁺).

It will be appreciated that various features of the process, for example relating to the overall process flow scheme, the electrolytic generation of the leach solution of oxidative halogen-based lixiviant, the conditions during leaching, metal separation to produce a metal-depleted solution, and regeneration of the lixiviant, are generally as described herein in the context of the process for leaching metals from metal sulfide ore and/or concentrate.

### Definitions

As used in this specification and the appended claims, the singular forms “a”, “an” and “the” include plural referents unless the content clearly dictates otherwise. Thus, for example, reference to an “oxidative lixiviant” includes a combination of two or more such processing reagents. Similarly, reference to a “metal sulfide ore” includes a combination of two or more such metal deposits.

Throughout the description and claims of the specification the word “comprise” and variations of the word, such as “comprising” and “comprises”, is not intended to exclude other additives, components, integers or steps. As used herein, “comprises” means “includes”. Thus, “comprising A or B,” means “including A, B, or A and B,” without excluding additional elements.

The term “and/or” as used herein is to be taken as specific disclosure of each of the two specified features or components with or without the other. For example “A and/or B” is to be taken as specific disclosure of each of (i) A, (ii) B and (iii) A and B, just as if each is set out individually herein.

### EXAMPLES

The invention will now be further explained and illustrated by reference to the following non-limiting examples. Unless otherwise specified, the chalcopyrite concentrate used in the examples was a chalcopyrite flotation concentrate (74% chalcopyrite) from Mount Isa Mines (Australia) with the following composition: Cu (24.5%), Fe (25.9%), S (28.6%), Si (5.2%), Mg (0.9%), Al (0.3%).

### Example 1

Samples of the chalcopyrite flotation concentrate were reacted with two different lixiviants, ferric sulfate and hypochlorous acid, to compare the leach kinetics. The chalcopyrite concentrate, screened to a particle size of −53+38, was combined (1 g) with 500 mL of lixiviant in a sealed Schott bottle. Experiments were agitated in a temperature controlled orbital shaker at 200 rpm for the duration of the experiment. The ferric sulfate solution was prepared with analytical grade sulfate salts to give a total ferric iron concentration of 15 g/L, at pH 1.5 (sulfuric acid). This solution was agitated at 70° C. The hypochlorous acid lixiviant (10 g/L) was prepared by adding technical grade NaOCl to deionised water and adjusting the pH to 4.0 with concentrated hydrochloric acid. This test was agitated at ambient temperature (23° C.) with the pH and ORP adjusted to starting conditions when samples were taken. Samples removed for copper analysis were filtered through a 0.2 μm pore-sized membrane before the copper concentration was determined using inductively coupled plasma atomic emission spectrometry (ICP-AES). The results, shown in FIG. 1, demonstrate that hypochlorous acid provides improved leaching kinetics and more complete extraction of copper from chalcopyrite concentrate than ferric sulfate leaching.

### Example 2

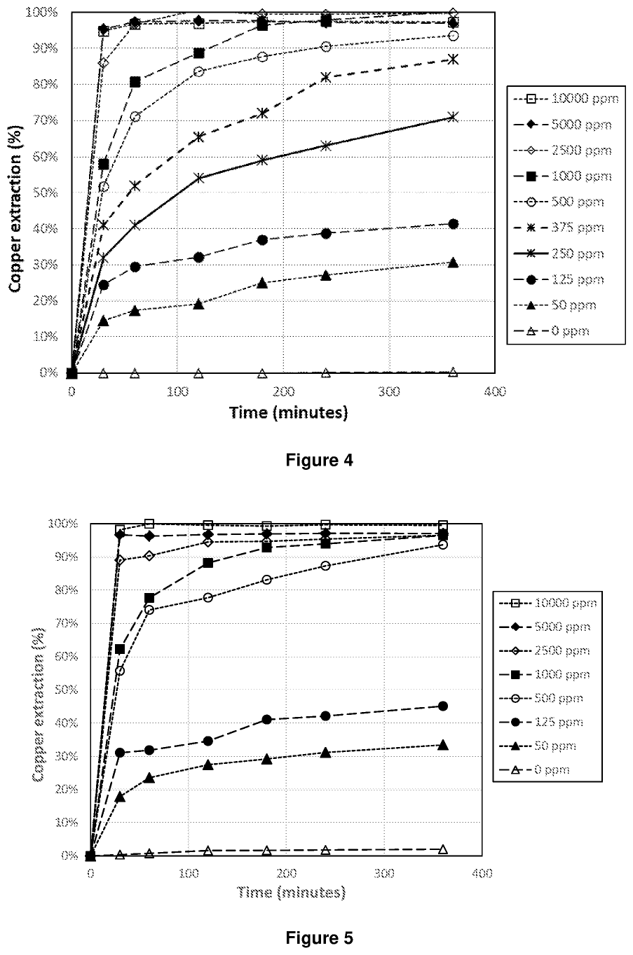

The extraction of copper from chalcopyrite over time at different lixiviant concentrations was investigated. Samples of the chalcopyrite flotation concentrate (screened to −53+38 μm) were reacted with hypochlorous acid at concentrations ranging from 0 to 10,000 mg/L NaClO (corresponding to 0.0007 mol/L, 0.0017 mol/L, 0.0034 mol/L, 0.0050 mol/L, 0.0067 mol/L, 0.0134 mol/L, 0.0336 mol/L, 0.0672 mol/L, 0.1343 mol/L lixiviant). The chalcopyrite concentrate (0.05 g) was combined with 500 mL of lixiviant in a sealed Schott bottle, except for tests conducted at 125 and 50 mg/L NaOCl which had lixiviant volumes of 690 and 1720 mL, respectively. Hypochlorous acid lixiviant was prepared by adding technical grade NaOCl to deionised water and adjusting the pH to 5.0 with concentrated sulfuric acid. Experiments were agitated at ambient temperature in an orbital shaker at 200 rpm for the duration of the experiment. During sampling, the pH was adjusted with sodium hydroxide solution (5% wt./v) to pH 5.0. Samples taken for copper analysis were filtered through a 0.2 μm pore-sized membrane before the copper concentration was determined using inductively coupled plasma atomic emission spectrometry (ICP-AES). The results, shown in FIG. 4, reveal that increasing concentration can result in more complete extraction in a shorter time. However, effective leaching still takes place at low concentrations, albeit at slower rates which are nevertheless superior to other commonly used industrial systems (such as ferric sulfate lixiviant).

### Example 3

The extraction of copper from chalcopyrite over time at different NaOCl concentrations was investigated. Samples of chalcopyrite flotation concentrate (screened to −53+38 μm) were reacted with hypochlorous acid at concentrations ranging from 0 to 10,000 mg/L NaClO. Chalcopyrite concentrate (0.05 g) was combined with 500 mL of lixiviant in a sealed Schott bottle, except for tests conducted at 125 and 50 mg/L NaOCl which had lixiviant volumes of 690 and 1720 mL, respectively. The hypochlorous acid lixiviant was prepared by adding technical grade NaOCl to deionised water and adjusting the pH to 5.0 with hydrochloric acid. Experiments were agitated at ambient temperature in an orbital shaker at 200 rpm for the duration of the experiment. During sampling, the pH was adjusted with sodium hydroxide solution (5% wt./v) to pH 5.0. Samples taken for copper analysis were filtered through a 0.2 μm pore-sized membrane before the copper concentration was determined using inductively coupled plasma atomic emission spectrometry (ICP-AES). The results, shown in FIG. 5, reveal that increasing concentration can result in more complete extraction in a shorter time but that effective leaching still takes place at low concentrations, albeit at slower rates. This result also demonstrates that extraction is independent of the acid present.

### Example 4

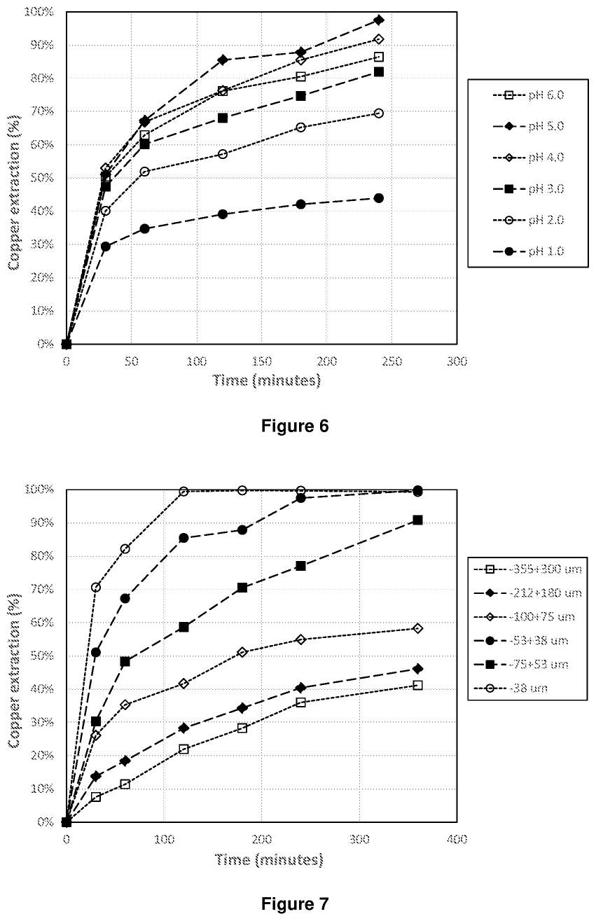

The extraction of copper from chalcopyrite over time at varied pH (sulfuric acid adjustment) was investigated. Samples of chalcopyrite flotation concentrate (screened to −53+38 μm) were reacted with hypochlorous acid at different pH, ranging from 1.0-6.0. The chalcopyrite concentrate (0.05 g) was combined with 500 mL of lixiviant in a sealed Schott bottle. Hypochlorous acid lixiviant (500 mg/L NaOCl corresponding to 0.00067 mol/L lixiviant) was prepared by adding technical grade NaOCl to deionised water and adjusting the pH to the target through addition of sulfuric acid. Experiments were agitated at ambient temperature in an orbital shaker at 200 rpm for the duration of the experiment. During sampling, the pH was adjusted with sodium hydroxide solution (5% wt./v) to the original target. Samples taken for copper analysis were filtered through a 0.2 μm pore-sized membrane before the copper concentration was determined using inductively coupled plasma atomic emission spectrometry (ICP-AES). The results, shown in FIG. 6, show that operation at pH of 3.0-6.0 results in comparable rates of leaching, being faster than operation at lower pH (1.0-2.0).

### Example 5

The extraction of copper from chalcopyrite over time at varied particle size fractions was investigated. Chalcopyrite concentrate samples of different particle size ranges were prepared via screening. The chalcopyrite flotation concentrate samples of different size fraction were then reacted with hypochlorous acid at pH 5.0. The chalcopyrite concentrate (0.05 g) was combined with 500 mL of lixiviant in a sealed Schott bottle. Hypochlorous acid lixiviant (500 mg/L NaOCl) was prepared by adding technical grade NaOCl to deionised water and adjusting to pH 5.0 through addition of sulfuric acid. Experiments were agitated at ambient temperature in an orbital shaker at 200 rpm for the duration of the experiment. During sampling, the pH was adjusted with sodium hydroxide solution (5% wt./v) to pH 5.0. Samples taken for copper analysis were filtered through a 0.2 μm pore-sized membrane before the copper concentration was determined using inductively coupled plasma atomic emission spectrometry (ICP-AES). The results, shown in FIG. 7, demonstrate that smaller size fractions achieve more complete leaching in a shorter time.

### Example 6

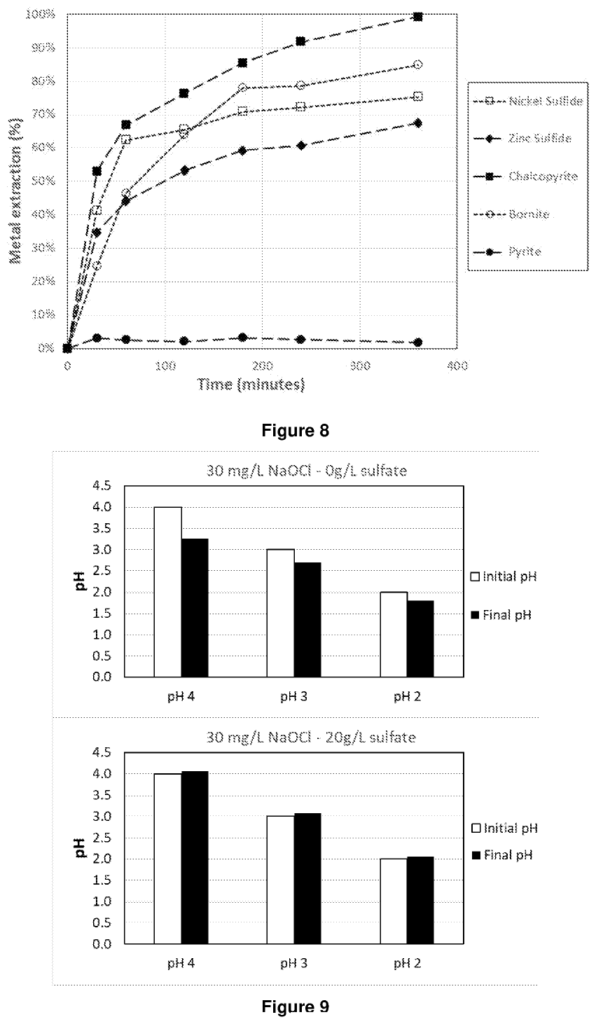

The extraction of metals from a range of different sulfide concentrates, including nickel sulfide (18% pure; 11.5% Ni), zinc sulfide (55% pure; 26% Zn), chalcopyrite (74% pure; 24.5% Cu), bornite (91% pure; 57.5% Cu) and pyrite (71% pure; 27.2% Fe), over time was investigated. Samples of mineral flotation concentrates (screened to −53+38 μm) were reacted with hypochlorous acid at pH 5.0. Concentrate from selected size fractions (0.05 g) was combined with 500 mL of lixiviant in a sealed Schott bottle. Hypochlorous acid lixiviant (500 mg/L NaOCl) was prepared by adding technical grade NaOCl to deionised water and adjusting to pH 5.0 through addition of sulfuric acid. Experiments were agitated at ambient temperature in an orbital shaker at 200 rpm for the duration of the experiment. During sampling, the pH was adjusted with sodium hydroxide solution (5% wt./v) to pH 5.0. Samples taken for copper analysis were filtered through a 0.2 μm pore-sized membrane before the copper concentration was determined using inductively coupled plasma atomic emission spectrometry (ICP-AES). The results, shown in FIG. 8, demonstrate that NaOCl facilitates extraction of various metals including zinc, copper and nickel, from their sulfide concentrates under the conditions used. These results also demonstrate that NaOCl may be useful in the selective extraction of some sulfide concentrates over others, such as chalcopyrite over pyrite, the latter showing little proclivity for leaching under the conditions used.

### Example 7

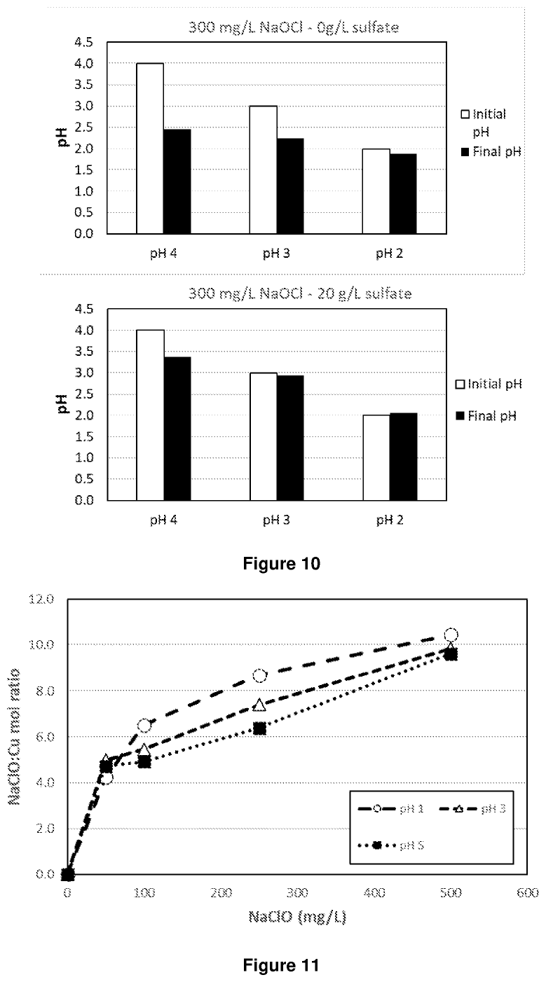

The extraction of copper from chalcopyrite was investigated at different pH and sulfate concentrations. Samples of chalcopyrite flotation concentrate (screened to −53+38 μm) were reacted with hypochlorous acid at concentrations of 30 or 300 mg/L NaClO. Chalcopyrite concentrate (0.05 g) was combined with 500 mL of lixiviant in a sealed Schott bottle. Hypochlorous acid lixiviant was prepared by adding technical grade NaOCl to deionised water, adding potassium sulfate salt to reach the required sulfate concentration (20 g/L=0.21 mol/L), then adjusting the pH to the target set point (2, 3 or 4) with concentrated sulfuric acid. Experiments were agitated at ambient temperature in an orbital shaker at 200 rpm until hypochlorous acid was consumed. Reagent consumption was inferred via monitoring the ORP, with final pH values measured and compared to initial values. The results, shown in FIG. 9 (30 mg/L NaOCl corresponding to 0.0004 mol/L lixiviant, with and without added sulfate) and FIG. 10 (300 mg/L NaOCl corresponding to 0.0040 mol/L lixiviant, with and without added sulfate), demonstrate that leaching with hypochlorous acid in the presence of additional sulfate results in a negligible change to pH conditions over the duration of experiments. The sulfate buffers the solution, thus preventing a substantial drop in pH despite the consumption of the hypochlorous acid.

### Example 8

The extraction of copper from excess chalcopyrite with hypochlorous acid was investigated at different pH and lixiviant concentrations to determine reactive molar ratios. Chalcopyrite concentrate (0.5 g, −53+38 μm) was combined with 500 mL of lixiviant in a sealed Schott bottle. Hypochlorous acid lixiviant (initial concentration 50, 100, 250 and 500 mg/L NaOCl, corresponding to 0.0007 mol/L, 0.0013 mol/L, 0.0034 mol/L, 0.0067 mol/L lixiviant) was prepared by adding technical grade NaOCl to deionised water and adjusting to pH 5.0 through addition of sulfuric acid. Experiments were agitated at ambient temperature in an orbital shaker at 200 rpm for the duration of the experiment. During sampling, the pH was adjusted with sodium hydroxide solution (5% wt./v) to pH 5.0. Samples taken for copper analysis were filtered through a 0.2 μm pore-sized membrane before the copper concentration was determined using inductively coupled plasma atomic emission spectrometry (ICP-AES). The results, shown in FIG. 11, demonstrate that leaching of copper from excess chalcopyrite with NaOCl will have improved reagent consumption efficiencies at low NaOCl concentrations.

### Example 9

The rate and efficiency of oxidative chlorine-based lixiviant generation using a commercial electrolyser was investigated at different pH values. Deionised water (50 L) containing 5 g/L sodium chloride was held in a 60 L drum. This solution was recirculated through a commercial salt water electrolyser (ChloroMate SP25, available from Profacture Australia) at a rate of 2.4 L per minute. The solution in the drum was agitated with an IKA Eurostar 60 overhead stirrer, equipped with a PTFE pitched 4-bladed impellor. During operation, concentrated sulfuric acid was added to maintain the solution pH at either 1.5 or 7.0. Tests were operated at ambient temperature, with solution pH and ORP measured continuously. The electrolyser was operated for a period of 2 hours, during which samples (20 mL) were removed and analysed for their NaOCl concentration via titration with a known ferrous sulfate solution at pH 1.5 to an electrochemical end-point (600 mV). Efficiency of NaOCl generation was estimated through use of a wall mounted power meter and clamp meter attached to the electrolyser.

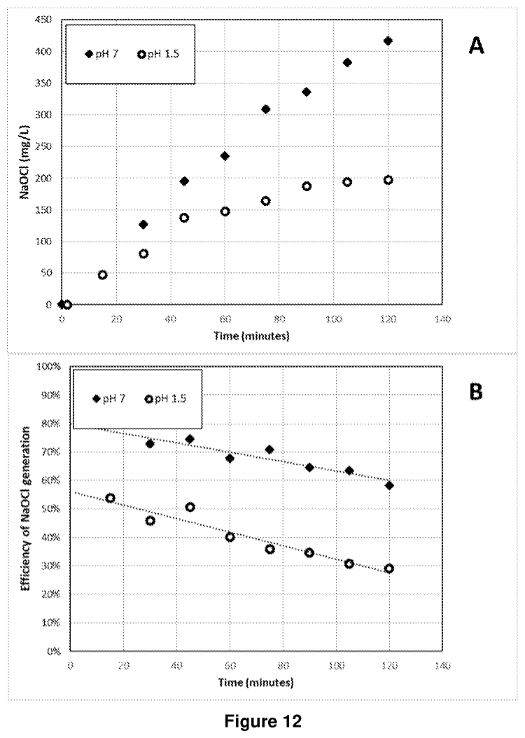

The results in FIG. 12, where FIG. 12A shows lixiviant concentration with time and FIG. 12B shows NaOCl generation efficiency with time, demonstrate that oxidative chlorine-based lixiviant can be electrolytically regenerated from halide solutions to concentrations suitable for leaching as demonstrated in Examples 1-8. Moreover, the regeneration can be conducted at a range of pH values expected in heap leaching lixiviants. However, the efficiency decreases with increasing conversion to lixiviant at both pH values, consistent with the equilibria in operation in the chlorination system. Without wishing to be limited by any theory, it is believed that efficiency reduces with increasing halide oxidation conversion due to one or more of cathodic, anodic and electrolyte losses of the HOCl product, proceeding via equations (2), (3) and (4) respectively.

$${ClO}^{-} + {H}_{2} O + 2 {e}^{-} \to {Cl}^{-} + 2 {OH}^{-} \qquad ( 2 )$$

$$6 HClO + 3 {H}_{2} O \to 3 {OH}^{-} + 4 {Cl}^{-} + 2 {ClO}_{{3}^{-}} + 12 {H}^{+} + 6 {e}^{-} \qquad ( 3 )$$

$$2 HClO \to 2 HCl + {O}_{2} \qquad ( 4 )$$

The efficiency is also found to be lower at low pH values. The plateau in lixiviant concentration at pH 1.5 may be due to off-gassing of Cl₂ (which is the most abundant equilibrium species at low pH) in addition to equilibrium limitations on further increases in concentration.

### Example 10

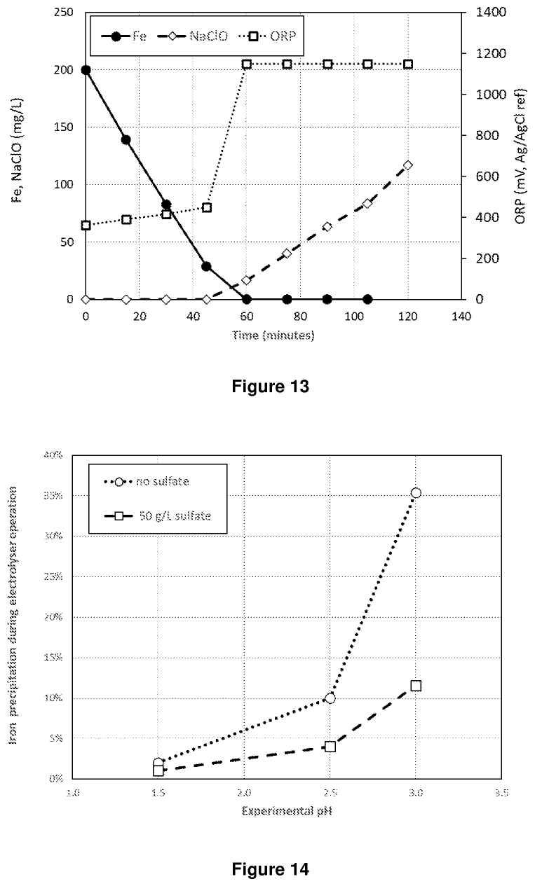

The impact of reduced, redox active soluble metal content (ferrous sulfate) during oxidative chlorine-based lixiviant regeneration using a commercial electrolyser was investigated. Deionised water (50 L) containing 5 g/L sodium chloride was held in a 60 L drum. This solution was recirculated through a commercial salt water electrolyser (ChloroMate SP25) at a rate of 2.4 L per minute. The solution in the drum was agitated with an IKA Eurostar 60 overhead stirrer, equipped with a PTFE 4 bladed impellor. Before the test commenced, 1 g/L of ferrous sulfate heptahydrate was added, and the pH was adjusted to 1.5 by addition of concentrated sulfuric acid after the metal sulfate salt was dissolved. During operation, concentrated sulfuric acid was added to maintain the solution pH at 1.5. Tests were operated at ambient temperature, with solution pH and ORP measured continuously. The electrolyser was operated for a period of 2 hours, during which samples (20 mL) were removed and analysed for their ferrous or NaOCl concentration. Soluble ferrous was analysed via titration with a standard solution of potassium dichromate. When the ORP was greater than 700 mV in the reaction vessel (drum) hypochlorous acid was determined via titration with ferrous sulfate solution at pH 1.5 to an electrochemical end-point (600 mV). The results, shown in FIG. 13, demonstrate that oxidative chlorine-based lixiviant will not accumulate in the bulk solution until reduced soluble iron content is oxidised.

### Example 11

The stability of soluble iron during hypochlorous acid generation in the presence and absence of additional sulfate salt was evaluated. Deionised water (50 L) containing 5 g/L sodium chloride and 200 mg/L ferric sulfate was held in a 60 L drum. The ferrous sulfate was oxidised to ferric sulfate by addition of hydrogen peroxide. The test with additional 50 g/L sulfate had this supplied through the addition of potassium sulfate. After dissolution of the salts, the solution was recirculated through a commercial salt water electrolyser (ChloroMate SP25) at a rate of 2.4 L per minute. The solution in the drum was agitated with an IKA Eurostar 60 overhead stirrer, equipped with a PTFE 4 bladed impellor. Before commencing the test, the pH was adjusted to the target pH set point (1.5, 2.5 or 3.0) by addition of concentrated sulfuric acid. During operation, concentrated sulfuric acid was added to maintain the pH at the target value. Tests were operated at ambient temperature, with solution pH and ORP measured continuously. The electrolyser was operated for a period of 2 hours to produce HOCl, during which samples (20 mL) were removed and analysed for iron content to determine the precipitated iron content. The results, shown in FIG. 14, demonstrate that iron precipitation after two hours increases at high pH values, but is suppressed by the presence of sulfate in solution.

### Example 12

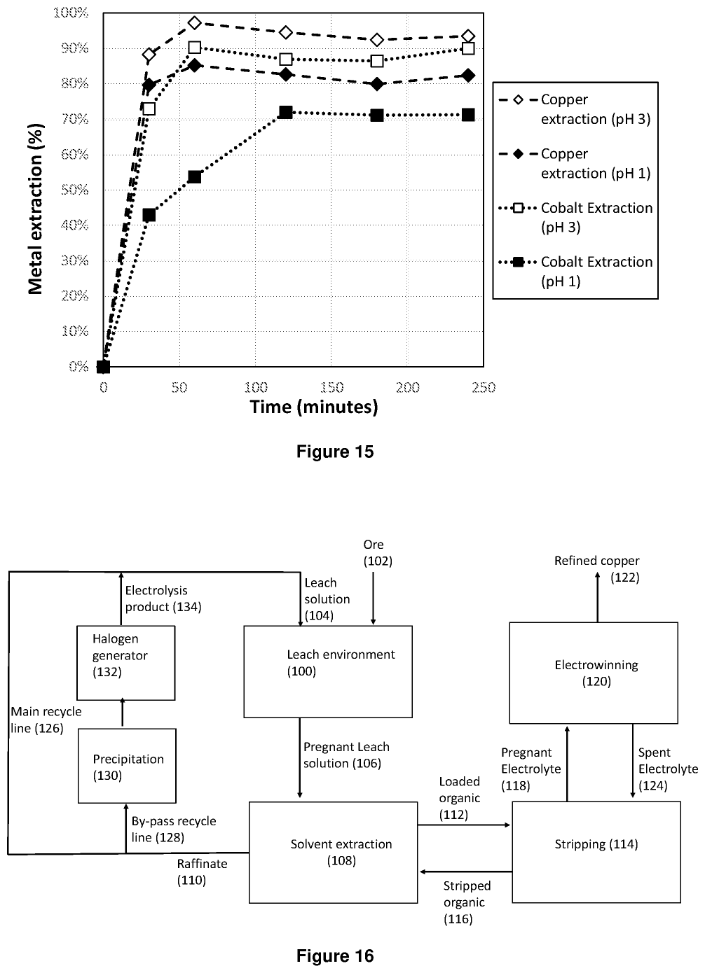

The extraction of copper and cobalt from a pulverised ore sample from a Queensland deposit (−53 μm) containing a mixture of sulfide minerals was investigated at different pH values. The pulverised ore sample (1 g) was reacted with the leach solution (3000 mg/L NaOCl, corresponding to 0.040 mol/L lixiviant) at pH 1 and 3. The sample was combined with 500 mL of lixiviant in a sealed bottle. Lixiviant was prepared by adding technical grade NaOCl to deionised water and adjusting to either pH 3.0 or 1.0 with sulfuric acid. Experiments were agitated at ambient temperature in an orbital shaker (200 rpm) for the duration of the experiment. During sampling, the pH was adjusted with sodium hydroxide solution (5% wt./v) to maintain target pH. Samples taken for metal analysis were filtered through a 0.2 μm pore-sized membrane before metal concentration was determined using inductively coupled plasma atomic emission spectrometry (ICP-AES). The results, shown in FIG. 15 demonstrate that an oxidative chlorine-based lixiviant can effectively extract multiple metals concurrently from a mixed mineral sample.

### Example 13

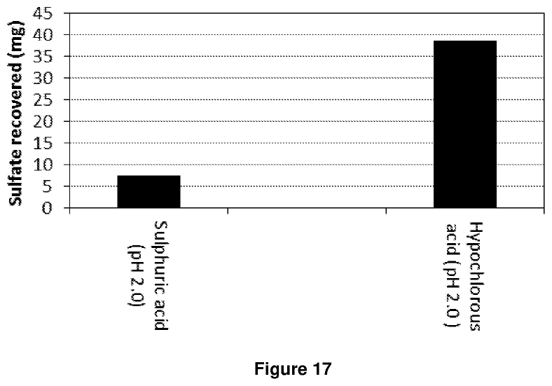

The solubilisation of sulfur from a sample of polysulfur into an acid solution in the presence and absence of hypochlorous acid was investigated. Synthetic polysulfur was prepared by adding 10.0 mL of 98% S₂Cl₂ (Aldrich) to 200 mL of distilled H₂O and 0.25 g of nonionic surfactant (Triton x100; Ajax Chemicals). The solution was stirred for 1 hour, after which solid polysulfide sulfur material was recovered by vacuum filtration. Residual surfactant was removed by resuspending the particles in distilled water, filtering and washing with ca. 2 L of distilled water. This wash process was repeated 4 times before drying at room temperature. 1 g of this material was added to 100 mL of pH 2 sulfuric acid. Triplicate tests were incubated at room temperature for 6 days before solution samples were removed for assay. A second set of triplicate tests were prepared with pH 2 sulfuric acid and 1000 mg/L NaClO, thus forming hypochlorous acid in situ. Solution sulfur content was measured by inductively coupled plasma atomic emission spectrometry (ICP-AES). The results, shown in FIG. 17, demonstrate that an oxidative chlorine-based lixiviant can effectively solubilise a polysulfur compound that may be present as a reaction product on mineral surfaces.

Those skilled in the art will appreciate that the invention described herein is susceptible to variations and modifications other than those specifically described. It is understood that the invention includes all such variations and modifications which fall within the spirit and scope of the present invention.

1. A process for leaching metals from metal sulfide ore and/or concentrate, comprising:
electrolytically generating a leach solution of oxidative halogen-based lixiviant;
contacting the metal sulfide ore and/or concentrate with the leach solution of oxidative halogen-based lixiviant to produce a metal-bearing solution; and
passing the metal-bearing solution to metal separation.

2. The process according to claim 1, wherein
electrolytically generating the leach solution comprises electrolytically oxidizing halide in an aqueous precursor solution to produce the oxidative halogen-based lixiviant in situ in the leach solution or in an aqueous feed to the leach solution.

3. (canceled)

4. The process according to claim 2, further comprising separating metal from the metal-bearing solution in metal separation to produce a metal-depleted solution comprising halide, and regenerating the oxidative halogen-based lixiviant following metal separation by recycling at least a portion of the metal-depleted solution to form at least a portion of the aqueous precursor solution.

5. The process according to claim 4, wherein the metal-depleted solution comprises soluble iron.

6. The process according to claim 2, wherein the aqueous precursor solution comprises sulfate.

7. The process according to claim 6, wherein the sulfate is present in the aqueous precursor solution at a concentration of at least 0.1 mol/L.

8. (canceled)

9. The process according to claim 1, wherein the oxidative halogen-based lixiviant comprises hypochlorous acid.

10. The process according to claim 1, wherein the leach solution for contacting the metal sulfide ore and/or concentrate comprises the oxidative halogen-based lixiviant at a concentration of less than about 0.05 mol/L.

11. The process according to claim 1, wherein the leach solution for contacting the metal sulfide ore and/or concentrate comprises the oxidative halogen-based lixiviant at a concentration of less than about 0.005 mol/L.

12. (canceled)

13. The process according to claim 1, wherein the leach solution for contacting the metal sulfide ore and/or concentrate has a pH of between 3 and 6.5.

14. The process according to claim 1, wherein the metal-bearing solution has a pH of at least 2 when passed to metal separation.

15. (canceled)

16. The process according to claim 1, wherein the leach solution for contacting the metal sulfide ore and/or concentrate comprises sulfate.

17. (canceled)

18. The process according to claim 1, wherein the oxidative halogen-based lixiviant is electrolytically generated using a halogen generator, wherein the halogen generator is located proximate to a leach environment comprising the sulfide ore and/or concentrate, and wherein the leach solution is transferred by line from the halogen generator to the leach environment for contact with the sulfide ore and/or concentrate.

19-22. (canceled)

23. The process according to claim 1, wherein the metal-bearing solution comprises at least one metal selected from copper, nickel, and cobalt leached from the metal sulfide ore and/or concentrate.

24. The process according to claim 1, wherein the metal sulfide ore and/or concentrate comprises a non-metallic oxidizable solid material other than a metal sulfide, and wherein at least a portion of the non-metallic oxidizable solid material is oxidized when contacting the metal sulfide ore and/or concentrate with the leach solution of oxidative halogen-based lixiviant.

25. (canceled)

26. The process according to claim 1, comprising leaching the metal sulfide ore and/or concentrate with a non-oxidative leach solution before and/or after contacting the metal sulfide ore and/or concentrate with the leach solution of oxidative halogen-based lixiviant.

27. An apparatus for leaching metals from metal sulfide ore and/or concentrate, comprising:
a halogen generator, wherein the halogen generator electrolytically generates a leach solution of oxidative halogen-based lixiviant;
a leach environment where the metal sulfide ore and/or concentrate is contacted with the leach solution of oxidative halogen-based lixiviant to produce a metal-bearing solution; and
means for metal separation from the metal-bearing solution.

28. The apparatus according to claim 27, wherein the halogen generator electrolytically oxidizes halide in an aqueous precursor solution to produce the oxidative halogen-based lixiviant in situ in the leach solution or in an aqueous feed to the leach solution.

29. The apparatus according to claim 27, further comprising a line for recycling a metal-depleted solution from metal separation to the halogen generator allowing for regeneration of the oxidative halogen-based lixiviant.

30-33. (canceled)

34. The apparatus according to claim 27, wherein the leach environment is a heap for heap leaching.
